(19) United States
(12) Patent Application Publication
(10) Pub. No.: US 2016/0162583 A1
(43) Pub. Date: Jun. 9, 2016

(54) APPARATUS AND METHOD FOR SEARCHING INFORMATION USING GRAPHICAL USER INTERFACE

(71) Applicant: Rhys Maddocks, Devon (GB)

(72) Inventor: Rhys Maddocks, Devon (GB)

(21) Appl. No.: 14/939,235

(22) Filed: Nov. 12, 2015

Related U.S. Application Data
(60) Provisional application No. 62/089,545, filed on Dec. 9, 2014.

(51) Int. Cl. G06F 17/30; G06F 3/0484; G06F 3/0482

(52) U.S. Cl. CPC G06F 17/30867; G06F 17/30554; G06F 3/0482; G06F 17/30398; G06F 3/04842

(57) ABSTRACT

An apparatus and a method for searching information using a graphical user interface are provided. In one aspect, an apparatus of the present disclosure comprises a display screen and a graphical user interface on the display screen, the graphical user interface being configured to display a first one of a plurality of search results received from a remote search server device in response to a search query, and one or more graphical features associated with said first one of the search results. At least one of the graphical features is configured to receive an action performed on the display screen that draws along a pre-determined direction to either accept or reject said first one of the search results, so as to modify the search query in accordance with the performed action and contents of said first one of the search results, thereby performing a refined search.

### BACKGROUND

The present disclosure relates to an apparatus and a method for searching information using a graphical user interface. More particularly, the present disclosure relates to an apparatus and a method for performing a vertical search of information using a graphical user interface to enter and/or modify search criteria, such apparatus and method being capable of differentiating homonyms in the searches.

Numerous standard web searching Application Programming Interfaces (APIs)/systems, such as Google, Bing, Apple, and Yandex, and vertical web searching APIs/systems, such as Indeed, have been developed and widely used by software developers. Through these search APIs, a user can easily provide queries to a remote search engine and return a set of matching results through the Internet to be displayed on a mobile application (or a mobile app) executed on a mobile electronic device, or a web browser program executed on a digital computer.

One problem with the existing search technologies is that they cannot differentiate between words that have multiple meanings. For example, if a user enters a keyword “Jobs” in the search field of a search engine (e.g., Google or Bing), current search technologies cannot determine whether to provide search results related to “Job listings” or related to the person “Steve Jobs.”

Another problem with the existing online search engines is that they tend to provide irrelevant results or results of no interests, even after multiple searches of the same keyword have been performed. These online search engines also tend to deliver a listing of search results formatted into separate web pages (usually 10 pages by default). Such listing of results requires a user to go through the pages, one after another, even for those results that are very similar to the ones the user has previously viewed and are not interested in.

In view of the above, there is a need to develop a new method and a new apparatus that can search information using a graphical user interface and that can differentiate homonyms in searches.

### SUMMARY

In one aspect, the present disclosure provides a method for searching information using a graphical user interface depicted by a terminal device, the method comprising: A) transmitting search criteria data to a search server device through a computer network to perform a preliminary search that returns preliminary search results; B) receiving the preliminary search results from the search server device through the computer network; C) displaying on the graphical user interface a first preliminary result of the preliminary search results and a first graphical feature associated with the first preliminary result; D) receiving an action performed to the displayed graphical feature so as to modify the search criteria data in accordance with contents included in the first preliminary result; E) transmitting the modified search criteria data to the search server device through the computer network to perform a refined search that returns refined search results; F) receiving the refined search results from the search server device through the computer network; and G) displaying on the graphical user interface a first refined result of the refined search results and a second graphical feature associated with the first refined result.

In one embodiment, the method further comprises, prior to A), preparing the search criteria data using one or more of a user's profile information and a user's location information. In one embodiment, preparing the search criteria data comprises composing a uniform resource locator (URL) string in accordance with an application program interface (API) configured to retrieve information from the search server device, the URL string including one or more of the user's profile information and the user's location information.

In one embodiment, D) comprises receiving the action performed to the displayed graphical feature that draws the graphical feature from a displayed position along a pre-determined direction that either accepts or rejects the first preliminary result. The method further comprises modifying the search criteria data to include at least some of the contents of the first preliminary result as a part of the modified search criteria data. The method further comprises adding the first preliminary result to a shortlist of accepted items when the graphical feature is drawn along a first direction that accepts the first preliminary result, and storing said shortlist of accepted items in a storage device of the search server device, The method further comprises adding the first preliminary result to a shortlist of rejected items when the graphical feature is drawn along a second direction that rejects the first preliminary result, and storing said shortlist of rejected items in a storage device of the search server device.

In one embodiment, C) comprises displaying on the graphical user interface an acceptance button, a rejection button, and a view button associated with the first preliminary result. The method further comprises receiving a click action performed to the view button and displaying detailed information associated with the first preliminary result.

In another aspect, the present disclosure provides a computer program product stored in a computer readable medium, the computer program product when executed by a processor of a terminal device, causing the processor to perform a method for searching information using a graphical user interface depicted by the terminal device, the method comprising: A) transmitting search criteria data to a search server device through a computer network to perform a preliminary search that returns preliminary search results; B) receiving the preliminary search results from the search server device through the computer network; C) displaying on the graphical user interface a first preliminary result of the preliminary search results and a first graphical feature associated with the first preliminary result; D) receiving an action performed to the displayed graphical feature so as to modify the search criteria data in accordance with contents included in the first preliminary result; E) transmitting the modified search criteria data to the search server device through the computer network to perform a refined search that returns refined search results; F) receiving the refined search results from the search server device through the computer network; and G) displaying on the graphical user interface a first refined result of the refined search results and a second graphical feature associated with the first refined result.

In still another aspect, the present disclosure provides an apparatus for searching information, the apparatus comprising a display screen, and a graphical user interface on the display screen, the graphical user interface being configured to display a first one of a plurality of search results received from a remote search server device in response to a search query, and one or more graphical features associated with said first one of the search results. At least one of the graphical features is configured to receive an action performed on the display screen that draws along a pre-determined direction to either accept or reject said first one of the search results, so as to modify the search query in accordance with the performed action and contents of said first one of the search results, thereby performing a refined search.

In one embodiment, the graphical features comprise an acceptance button, a rejection button, and a view button associated with said first one of the search results. The acceptance button is configured to receive a first drawing action performed on the display screen along a first direction, and the rejection button is configured to receive a drawing action performed on the display screen along a second direction, the second direction being different from the first direction. The view button is configured to receive a click action performed on the display screen to display detailed information of said first one of the search results.

### BRIEF DESCRIPTION OF THE DRAWINGS

For a better understanding of the present disclosure, together with other and further needs thereof, reference is made to the accompanying drawings and detailed description.

FIG. 1 illustrates a system for performing vertical search, in accordance with an embodiment of the present disclosure.

FIG. 2 illustrates a flow diagram of a method for performing vertical search, in accordance with an embodiment of the present disclosure.

FIGS. 3A and 3B illustrate a graphic user interface for receiving user profile information as a part of the searching criteria, in accordance with an embodiment of the present disclosure.

FIG. 4 illustrates a graphic user interface for specifying location information as a part of the searching criteria, in accordance with an embodiment of the present disclosure.

FIG. 5 illustrates a graphic user interface when performing a search, in accordance with an embodiment of the present disclosure.

FIG. 6 illustrates a graphic user interface for selectively accepting/rejecting individual search results, in accordance with an embodiment of the present disclosure.

FIGS. 7A and 7B illustrate a graphic user interface respectively showing a shortlist of accepted and deleted search results, in accordance with an embodiment of the present disclosure.

### DETAILED DESCRIPTION

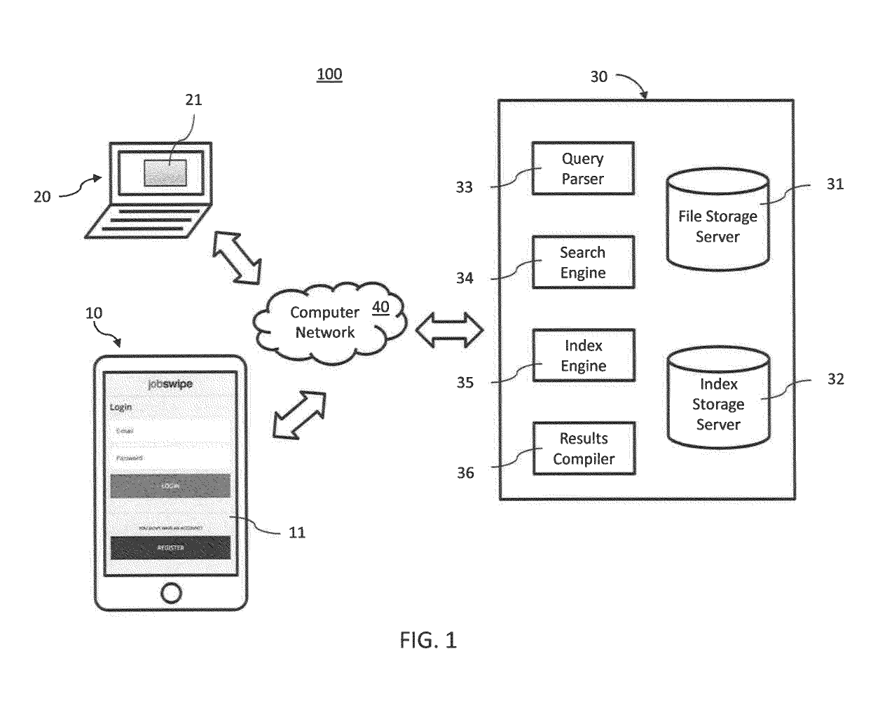

Hereafter, embodiments of the present disclosure are described in further detail with reference to the accompanying drawings. FIG. 1 illustrates a system 100 for performing a vertical search, in accordance with an embodiment of the present disclosure. The vertical search, as described herein, can be performed by a vertical search engine, which focuses on the search of a specific topic or set of topics of online contents, as distinct from a general web search engine. Vertical search engines typically use a focused crawler to retrieve online contents or web pages that are relevant to a specific topic or set of topics, and index the retrieved contents for focused searches.

As shown in FIG. 1, system 100 includes a search server 30 configured to receive search queries from and generate search results to a mobile device 10 and/or a computer device 20 through a computer network 40. Mobile device 10 may be a smartphone, a tablet computer, and the like. Computer device 20 may be a laptop computer, a desktop computer, and the like. Computer network 40 may be a wide area network, a wireless data network, an optical fiber network, and the like.

Referring to FIG. 1, mobile device 10 includes a graphical user interface (GUI) 11 configured to display output and receive user input, in accordance with an embodiment of the present disclosure. In one case, the graphical user interface may be implemented as a mobile app that outputs information through a flat panel display of mobile device 10 and receives user instructions through a touch sensitive panel of mobile device 10.

Referring again to FIG. 1, computer device 20 includes a graphical user interface (GUI) 21 configured to display output and receive user input, in accordance with an embodiment of the present disclosure. In one case, the graphical user interface is implemented as a web browser program that outputs information through display device of computer device 20 and receives user instructions through a keyboard and/or a pointing device coupled to computer device 20.

Referring still to FIG. 1, search server 30 comprises a file storage server 31, an index storage server 32, a query parser 33, a search engine 34, an index engine 35, and a results compiler 36. In one implementation, search server 30 may include a single server device or a cluster of server devices, each including a microprocessor, a volatile memory (e.g., RAM), a non-volatile memory (e.g., hard drive, flash memory, etc.), and other peripheral devices (e.g., Ethernet card, USB ports, etc.). Although physical hardware is always required as the underlying infrastructure for search server 30, it is appreciated that some or all components of search server 30 (such as, query parser 33, search engine 34, index engine 35, and results compiler 36) may be virtualized as software defined/emulated hardware devices (e.g., a virtual machine).

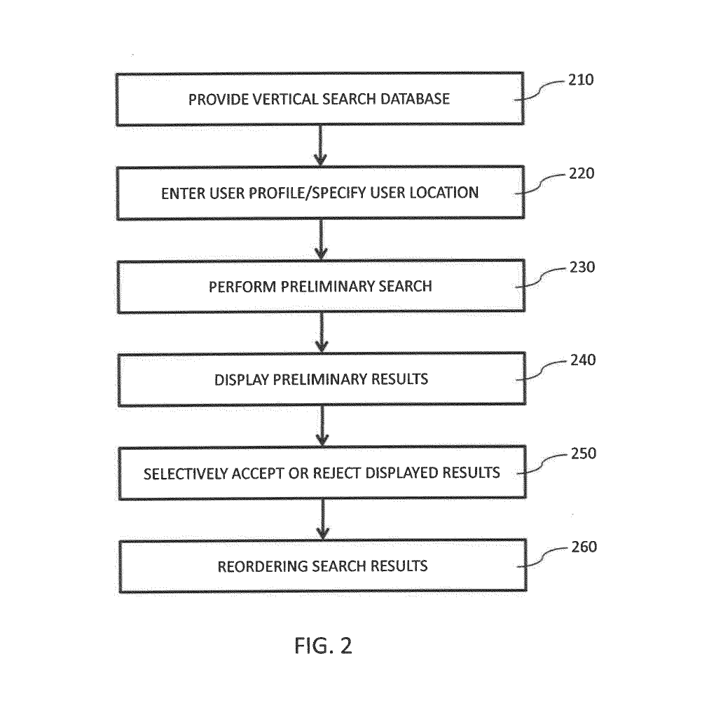

FIG. 2 illustrates a flow diagram of a method for performing a vertical search, in accordance with an embodiment of the present disclosure. Referring to both FIGS. 1 and 2, in Step 210, a vertical search database is prepared and stored in file storage server 310. The vertical search database may be hosted on commercially available Microsoft SQL Server, and accessible via commercially available Microsoft IIS Web server. The vertical search database may include contents of a specific topic or context. By way of an example, the present disclosure discusses job searches of a job bank. It is appreciated that the present disclosure is equally applicable to vertical searches of other topics or contexts, such as, cars, music, real property, electronic commerce, holiday gifts, scientific journals, etc.

In one embodiment, the vertical search database is prepared by collecting a plurality of job postings from employers, each posting being represented by a data file and stored in file storage server 31. In alternative embodiments, the vertical search database can be prepared by crawling job postings from other job searching websites. Index engine 34 can then analyze the job postings and prepare an index database in accordance with keywords included in the job postings. In one embodiment, index engine 34 is implemented using components of an open source information retrieval software library, e.g., Apache Lucene, so as to index keywords in the job postings, prepare the index database, and store the index database in index storage server 32.

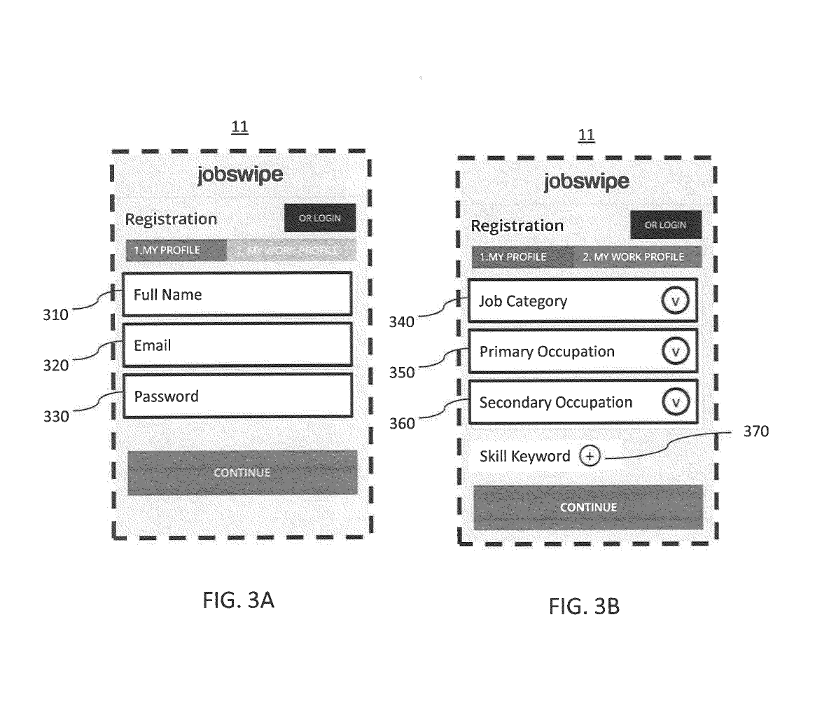

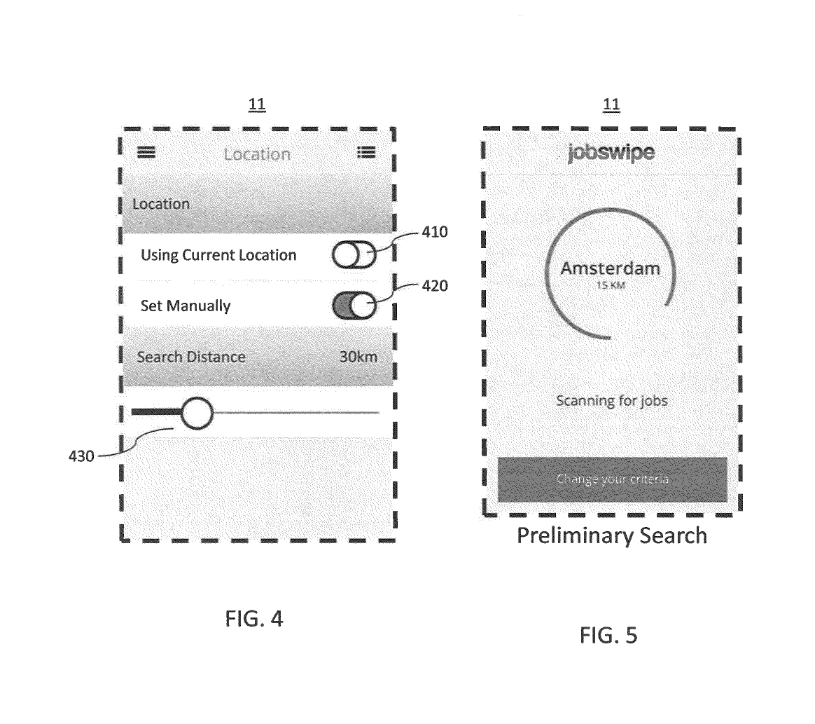

Referring again to FIGS. 1 and 2, in Step 220, a user may enter user profile information and/or specify user location information through, for example, graphical user interface 11 of mobile device 10 or graphical user interface 21 of computer device 20. FIGS. 3A and 3B illustrate graphical user interface 11 for receiving the user profile information, in accordance with an embodiment of the present disclosure. FIG. 4 illustrates graphic user interface 11 for specifying the location information, in accordance with an embodiment of the present disclosure.

As shown in FIGS. 3A and 3B, graphical user interface 11 includes multiple fields 310-360 for entry of the user's profile information, In this embodiment, the user profile information includes the user's full name (entered through field 310), the user's email (entered through field 320), the user's password (entered through field 330), the user's job category (entered through field 340), the user's primary occupation information (entered through field 350), and the user's secondary occupation information (optional) (entered through field 360). Further, the user may additionally specify skill keywords by clicking on an expansion button 370 displayed on graphical user interface 11. Upon entry of the user's profile information, the mobile app constituting graphical user interface 11 generates an initial query string (such as a URL of “http://api.jobswipe.net/personalisedjobs/{token}”) based at least in part on the user's profile information to perform a preliminary search.

In an alternative embodiment, the user may additionally or alternatively specify location information in the initial query string for the preliminary search. FIG. 4 illustrates graphic user interface 11 for specifying a user's location information, in accordance with an embodiment of the present disclosure. For example, a user can turn on (swipe right) a first virtual switch 410 of graphical user interface 11 to use the mobile device's current location information, or turn off (swipe left) first virtual switch 410 to disable the use of current location information. In addition, a user can turn on (swipe right) a second virtual switch 420 of graphical user interface 11 to manually set up the location information, or turn off (swipe left) second virtual switch 420 to disable manual setup. Further, a user can use a scroll bar 430 of graphical user interface 11 to specify a geographical range to be searched (e.g., within a 30 km distance from the current location or the manually set location).

Referring to FIGS. 1 and 2, in Step 230, upon entry of the user's profile information and/or the user's location information, an initial query string can be generated by the mobile app executed on mobile device 10 and transmitted to query parser 33 of search server 30 through computer network 40. Query parser 33 then analyzes the initial query string and passes instructions or searching criteria contained in the initial query string to search engine 34, so as to perform the preliminary search. In accordance with the instructions, search engine 34 searches for data files (e.g., job postings) in file storage server 31 that match the searching criteria using, for example, the index database in index storage server 32. FIG. 5 illustrates graphic user interface 11 of mobile device 10 when performing the preliminary search, in accordance with an embodiment of the present disclosure.

In one embodiment, the preliminary search returns no result. As such, a user may modify the search criteria by, for example, editing the user's profile information and/or the user's location information, so as to perform another search. In one embodiment, the preliminary search returns a plurality of data files (or job profiles) as search results. As such, search engine 340 passes the returned data files to results compiler 360. Instead of returning pages of search results, results compiler 360 organizes the data files into a stack of “cards” and transmits the organized search results to mobile device 10.

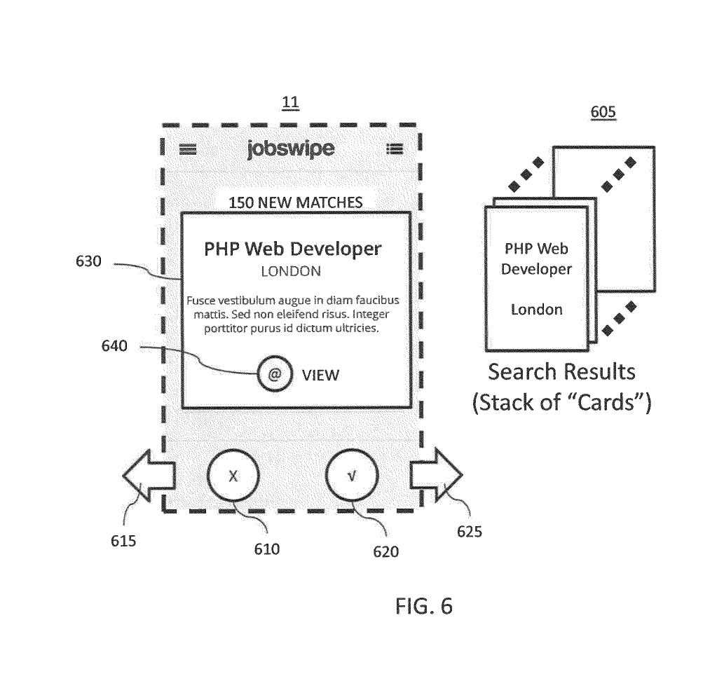

Referring to FIGS. 1 and 2, in Step 240, the preliminary search results can be displayed on graphical user interface 11 of mobile device 10 for user interaction and further processing. FIG. 6 illustrates graphic user interface 11 for selectively accepting/rejecting search results, in accordance with an embodiment of the present disclosure, As shown in FIG. 6, search results 605 can be organized as a stack of “cards” and a first result (or first card) 630 can be the most relevant result and displayed on graphical user interface 11. The user can accept or reject the first card 630 by interacting with graphical user interface 11.

Referring to FIGS. 1 and 2, in Step 250, the displayed results can be selectively accepted or rejected by interacting with graphical user interface 11 of mobile device 10. For example, if the displayed card 630 is not of interest or deemed irrelevant, a user can swipe the displayed card 630 to the left (Le., to reject card 630) using a finger to draw, for example, a rejection button 610 displayed on a predetermined position of graphical user interface 11 along a first direction 615. Likewise, if the displayed card 630 is of interest or deemed relevant, a user can swipe the displayed card 630 to the right (i.e., to accept card 630) and add card 630 to a shortlist by using a finger to draw, for example, an acceptance button 620 displayed on a predetermined position of graphical user interface 11 along a second direction 625. It is appreciated that, in alternative embodiments, a displayed card can be swiped along any direction in accordance with design choices.

As shown in FIG. 6, the displayed card 630 can carry title (e.g., “PHP Web Developer, London”) and snippet data, as well as a view button 640 to view the full data file, It is appreciated that the disclosed “cards” are not limited to job postings and can be customized depending on specific applications or vertical search topics. Moreover, a user may review detailed information of the job profile corresponding to the displayed card 630 by clicking/pressing on view button 640 of graphical user interface 11.

Referring to FIGS. 1 and 2, in Step 260, the search results or the stack of cards can be reordered in accordance with the acceptance/rejection of previously displayed cards. For example, each time a swipe is performed, the keywords contained in the swiped card is noted, and the remaining search results in the stack can be reordered in accordance with the type of swipe (positive/accept or negative/reject). As such, the present disclosure provides a system and a method that can differentiate homonyms in searches.

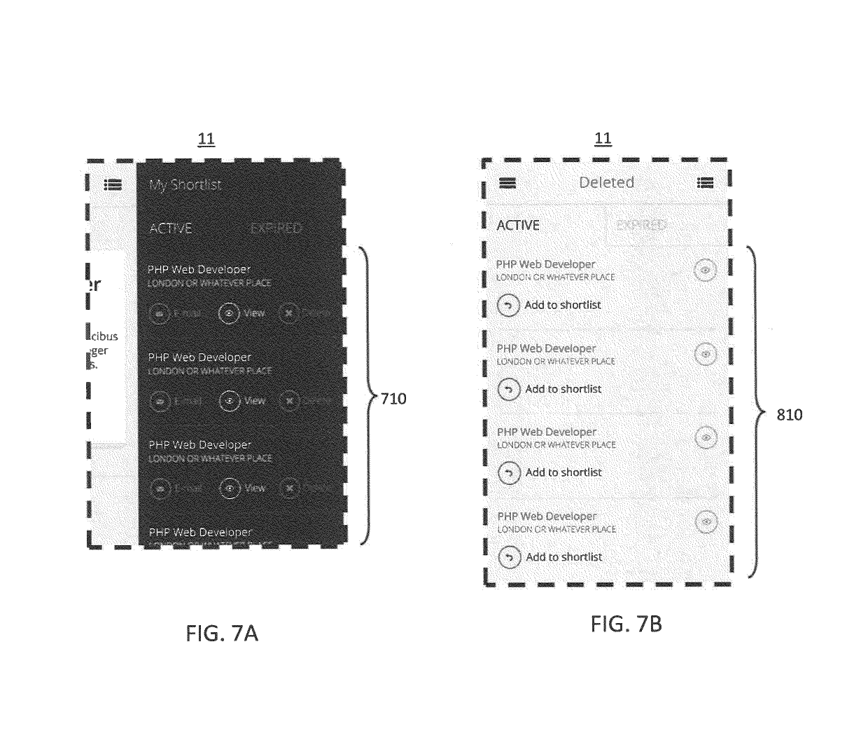

For example, in the case of search for “jobs” and getting a mix of results with “Job Listings” and “Steve Jobs,” if a user then swipe right (accept) on a card with information related to “Steve Jobs,” the system of the present disclosure can store the accepted card in a shortlist of relevant results, note the keyword of “Steve Jobs,” and reorder the search results with results more relevant to “Steve Jobs” appearing first or with higher priority. In addition, if the previously displayed card contains a keyword of “London” as the location information and is swiped right or accepted, the remaining search results will be reordered such that those other results having a “London” location are ranked higher and appear earlier in the stack, and that those other results having a different location are ranked lower and appear later in the stack. FIGS. 7A and 7B illustrate graphic user interface 11 respectively showing a shortlist of accepted cards 710 and a list of rejected/deleted cards 810, in accordance with an embodiment of the present disclosure.

### EXEMPLARY IMPLEMENTATION

In one implementation, an API (application programming interface) is first developed to accept searching criteria, such as keywords, or to set searching criteria. For example, for a real property search application, the keywords can be “one bedroom rental properties,” and search server 30 can return a set of results. In one embodiment, client processes on mobile device 10 can interact with server API process on search server 30. The API can use information gleaned from the swipes to increase the relevancy of the next search results. This may be referred to as an intelligent search mechanism as the API learns from the activity of the searcher and generates improved results based on the swipes (i.e., the more swipes performed, the better the search results).

1. Software Application

A content access software application (CASA), such as, a native application (installable and executable under an operating system, e.g., iOS or windows), a web application (executable over a web browser program), a mobile application (e.g., made available through a mobile app store), or a hybrid application a native application with the functionalities of a web application), can be developed to interact with the API and pass the search criteria to the search server 30. Then, search results can be retrieved from the API and displayed on, for example, mobile device 10 as a stack of cards, including some of the cards' detailed data. The software application is configured to render graphical user interface 11 that allows the displayed top card to be swiped left (not relevant) or right (relevant). Cards that contain relevant data are then saved in a shortlist. In one embodiment, the shortlist can be a data file stored either in a client-side non-volatile storage device, such as a flash memory of mobile device 10 or a hard drive of computer device 20, or in a remote non-volatile storage device, such as file storage server 31 of search server 30.

The CASA can call the API to inform search server 30 of the swipes and to get the latest version of the search results stack from search server 30. The CASA can also store search histories and enable the user to update/modify search criteria. The CASA allows for location based searches based on the longitude and latitude that can be configured or derived within the content access software application. The CASA calls various API to register or log the user into system 30, and then send search criteria to the API.

The CASA can display the search results in a stack and then allow the swiping of the results based on whether they are relevant or not. The CASA also allows the full details of a results to be viewed, such as the webpage or full job description, etc. The CASA makes API calls based on the view or swipe actions to update the database on the action performed. The CASA also allows the user to view the shortlisted items.

2. API

The API loads into a search database (e.g., the vertical search database in file storage server 31) searchable data, which can come from a variety of sources (e.g., XML data feeds, scans, dumps, etc.) and can be accompanied by other data files, such as images, video, music, documents, etc. The searchable data is then loaded into temporary data tables, and then synced with the live data periodically to make sure the live data is up-to-date and any expired data is flagged as expired. The database data is then exported to a vector space model index (e.g., index database in index storage server 32) using, for example, Lucene, to improve performance over standard SQL searches of the data and to improve relevance ranking of the results. The API allows for a user to be registered and to later login and retrieve their settings such as previous searches, shortlists, personal data and settings.

When a search is performed using the CASA, the API is called to return relevant results from the search database via, for example, the Lucene index. The search results can be returned to the CASA in XML format as ranked list of results, including title and snippets of the data. In certain cases, image/music/video file data and a link to the complete data file can be displayed. The CASA displays the search result data to the user in a stack with the first result on top of the stack being the only result viewable within graphical user interface 11.

In this implementation, three actions can be taken with the displayed first stack. First, a user can view the full data file by clicking on the link to the data file. As a result, the API is called, informing the search database that this action has been performed and the database is updated in relation to this record.

Second, a user can swipe the displayed first stack as being not relevant. The API is called, informing the search database that such action has been performed and the search database is updated in relation to the record. The API is then called for the latest set of results and displays a new stack after having updated the search results based on the outcome of the swipe.

Third, a user can swipe the displayed first stack as being relevant and store the swiped stack into a shortlist. The API is called, informing the search database that such action has been performed and the search database is updated in relation to the record. The API is then called for the latest set of results and displays a new stack after having updated the search results based on the outcome of the swipe.

In this implementation, relevant items (items in the shortlist) are stored in the search database and can be retrieved via the API. The relevant items can be viewed from within the shortlist, or emailed or deleted via an API call.

In this implementation, irrelevant items are stored in the search database and can be retrieved via the API. In some instances, the CACA allows for deleted items to be viewed and moved to a shortlist, as the deletion may be a mistake.

3. Positive Relevant Swipes

In the case of positives swipes (stacks swiped as relevant), the keyword data in the stack record can be added into the search criteria for updated searches. The added keyword data can relate to the data of the swiped item or the location of the swiped item, In the case of keywords, a collection of positive keywords (and keyword groups) can be built up and added to, if required, from the data in the shortlisted items. For example, when a user is searching for a manager job, a group of results are returned and shortlisted as account manager job. “Account manager” can then be added as a keyword group to the updated search.

In addition, the conditions in the stack record of a positive swipe can also be added into the search criteria for updated searches. For example, when a user is searching to buy a 2 bedroom house in Los Angeles, and swiped a posting of a house priced at $500K into a shortlist, this price condition can be added into the search criteria for updated searches. As a result, the new, updated search results give greater relevance to real properties around that pricing range of $500K.

In the case of locations, the search location data can be expanded or moved to relate to the new shortlisted item. In the CASA, users can set their current location or choose a location and then set a distance (e.g., 30 km) from this location that they are interested in matching items.

When a user performs positive swipes on two or more separate items that are deemed relevant, a relationship can be created between those swiped items, For example, two positive swipes in a shortlist may share certain keywords and/or conditions. Such shared keywords and/or conditions may be aggregated from the positive swipes and a shortlist linking thereof can be given a greatest relevancy weighting within the search results.

4. Negative Irrelevant Swipes

When new search results are compiled, these search results can be compared to negative items that are deemed as not relevant. If some of the new search results show a very high degree of similarity with the irrelevant items in a shortlist, they can be excluded (Le., duplicate exclusion) from the new search results, because they might be duplicate contents or contents from different providers that are nearly identical, e.g., same job posted on different sites. Content duplication is very common in web searches, and it is very useful not having to view duplicated contents. In this implementation, negative keywords can also be compiled from the negative items and used to effect the search results.

Further, when a user performs negative swipes on two or more separate items, a relationship can be created between those swiped items. This relationship can also be used to eliminate some items in the search results. The negative swipe effects (or negative exclusion) can be used as needed, depending on the volume of returned results. In cases of low return results, such negative exclusion can be disabled, leaving only the duplicate exclusion enabled.

5. Content/Information Provider

From a content/information provider's point of view, a more accurate picture of the requirements of a searcher can be accrued and feedback can be given to the service provider. For example if a job advertisement is placed and posted in an online job searching system, the system can inform the job poster in how many possible search results are the job advertisement shown to the users. It can also provide information back to the service provider on how many people have looked at the job profile or swiped the job profile left or right (relevant or irrelevant). This is valuable information to a content provider, such as an employer. Current job search sites can only tell how many people have viewed the job posting, and cannot give accurate data on their interactions with job searchers.

For the purposes of describing and defining the present teachings, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue.

Although the present disclosure has been described with respect to various embodiments, it would be apparent to one of ordinary skill in the art that various other embodiments are possible, without departing from the spirit and scope as defined in the appended claims.

What is claimed is:

1. A method for searching information using a graphical user interface depicted by a terminal device, the method comprising:
A) transmitting search criteria data to a search server device through a computer network to perform a preliminary search that returns preliminary search results;
B) receiving the preliminary search results from the search server device through the computer network;
C) displaying on the graphical user interface a first preliminary result of the preliminary search results and a first graphical feature associated with the first preliminary result;
D) receiving an action performed to the displayed graphical feature so as to modify the search criteria data in accordance with contents included in the first preliminary result;
E) transmitting the modified search criteria data to the search server device through the computer network to perform a refined search that returns refined search results;
F) receiving the refined search results from the search server device through the computer network; and
G) displaying on the graphical user interface a first refined result of the refined search results and a second graphical feature associated with the first refined result.

2. The method of claim 1, further comprising, prior to A), preparing the search criteria data using one or more of a user's profile information and a user's location information.

3. The method of claim 2, wherein preparing the search criteria data comprises composing a uniform resource locator (URL) string in accordance with an application program interface (API) configured to retrieve information from the search server device, the URL string including one or more of the user's profile information and the user's location information.

4. The method of claim 1, wherein D) comprises receiving the action performed to the displayed graphical feature that draws the graphical feature from a displayed position along a pre-determined direction that either accepts or rejects the first preliminary result.

5. The method of claim 4, further comprising modifying the search criteria data to include at least some of the contents of the first preliminary result as a part of the modified search criteria data.

6. The method of claim 5, further comprising adding the first preliminary result to a shortlist of accepted items when the graphical feature is drawn along a first direction that accepts the first preliminary result, and storing said shortlist of accepted items in a storage device of the search server device.

6. The method of claim 5, further comprising adding the first preliminary result to a shortlist of rejected items when the graphical feature is drawn along a second direction that rejects the first preliminary result, and storing said shortlist of rejected items in a storage device of the search server device.

7. The method of claim 1, wherein C) comprises displaying on the graphical user interface an acceptance button, a rejection button, and a view button associated with the first preliminary result.

8. The method of claim 7, further comprising receiving a click action performed to the view button and displaying detailed information associated with the first preliminary result.

9. A computer program product stored in a computer readable medium, the computer program product when executed by a processor of a terminal device, causing the processor to perform a method for searching information using a graphical user interface depicted by the terminal device, the method comprising:
A) transmitting search criteria data to a search server device through a computer network to perform a preliminary search that returns preliminary search results;
B) receiving the preliminary search results from the search server device through the computer network;
C) displaying on the graphical user interface a first preliminary result of the preliminary search results and a first graphical feature associated with the first preliminary result;
D) receiving an action performed to the displayed graphical feature so as to modify the search criteria data in accordance with contents included in the first preliminary result;
E) transmitting the modified search criteria data to the search server device through the computer network to perform a refined search that returns refined search results;
F) receiving the refined search results from the search server device through the computer network; and
G) displaying on the graphical user interface a first refined result of the refined search results and a second graphical feature associated with the first refined result.

10. The computer program product of claim 9, further comprising, prior to A), preparing the search criteria data using one or more of a user's profile information and a user's location information.

11. The computer program product of claim 10, wherein preparing the search criteria data comprises composing a uniform resource locator (URL) string in accordance with an application program interface (API) configured to retrieve information from the search server device, the URL string including one or more of the user's profile information and the user's location information.

12. The computer program product of claim 9, wherein D) comprises receiving the action performed to the displayed graphical feature that draws the graphical feature from a displayed position along a pre-determined direction that either accepts or rejects the first preliminary result.

13. The computer program product of claim 12, further comprising modifying the search criteria data to include at least some of the contents of the first preliminary result as a part of the modified search criteria data.

14. The computer program product of claim 13, further comprising adding the first preliminary result to a shortlist of accepted items when the graphical feature is drawn along a first direction that accepts the first preliminary result, and storing said shortlist of accepted items in a storage device of the search server device.

15. The computer program product of claim 14, further comprising adding the first preliminary result to a shortlist of rejected items when the graphical feature is drawn along a second direction that rejects the first preliminary result, and storing said shortlist of rejected items in a storage device of the search server device.

16. The computer program product of claim 9, wherein C) comprises displaying on the graphical user interface an acceptance button, a rejection button, and a view button associated with the first preliminary result.

17. The computer program product of claim 16, further comprising receiving a click action performed to the view button and displaying detailed information associated with the first preliminary result.

18. An apparatus for searching information, the apparatus comprising:
a display screen; and
a graphical user interface on the display screen, the graphical user interface being configured to display a first one of a plurality of search results received from a remote search server device in response to a search query, and one or more graphical features associated with said first one of the search results;
wherein at least one of the graphical features is configured to receive an action performed on the display screen that draws along a pre-determined direction to either accept or reject said first one of the search results, so as to modify the search query in accordance with the performed action and contents of said first one of the search results, thereby performing a refined search.

19. The apparatus of claim 13, wherein the graphical features comprise an acceptance button, a rejection button, and a view button associated with said first one of the search results.

20. The apparatus of claim 19, wherein the acceptance button is configured to receive a first drawing action performed on the display screen along a first direction, and the rejection button is configured to receive a drawing action performed on the display screen along a second direction, the second direction being different from the first direction.

21. The apparatus of claim 19, wherein the view button is configured to receive a cock action performed on the display screen to display detailed information of said first one of the search results.
